(19) United States
(12) Patent Application Publication
(10) Pub. No.: US 2021/0026461 A1
(43) Pub. Date: Jan. 28, 2021

(54) INDEPENDENT INPUTTING DEVICE WITH SELF-LEARNING FUNCTION

(71) Applicant: PRIMAX ELECTRONICS LTD., Taipei City (TW)

(72) Inventors: SHIH-CHIEH HSU, Taipei City (TW); WEN-CHIH SHEN, Taipei City (TW); WEI-LUNG HUANG, Taipei City (TW); PEI-MING CHANG, Taipei City (TW); PAO-CHUNG CHAO, Taipei City (TW)

(21) Appl. No.: 16/592,451

(22) Filed: Oct. 3, 2019

(30) Foreign Application Priority Data
Jul. 26, 2019 (TW) 108126603

(51) Int. Cl. G06F 3/023; G06F 3/042; G06F 17/27

(52) U.S. Cl. CPC G06F 3/0237; G06F 17/2735; G06F 17/276; G06F 3/0426

(57) ABSTRACT

Disclosures of the present invention describe an independent inputting device with self-learning function. During a user inputting a vocabulary word and/or a sentence, this independent inputting device can forecast what vocabulary word is that the user desires to input in case of a number of inputted letters of the vocabulary word reaching a threshold integer (═N). Consequently, this independent inputting device automatically completes the inputting of those un-inputted letters of the vocabulary word, such that the user does no longer continue the inputting of those un-inputted letters of the vocabulary word. As such, when the user adopts one input method to edit a program code, write an article or a letter, or make statistical forms, inputting speed of the typed vocabulary words can be apparently increased by this independent inputting device, thereby largely enhancing the user's work efficiency.

### FIELD OF THE INVENTION

The present invention relates to the field of word input autocompleting systems, and in particular, to an independent inputting device with self-learning function for automatically memorizing and learning user's specific habit of using vocabulary word(s) or sentences.

### BACKGROUND OF THE INVENTION

Keyboard is a well-known inputting device that is configured for a user to input figures and/or vocabulary word(s) into a computer device by way of typing. In general, there is at least one input method implemented in an operating system (OS) of commercial computer devices. For example, Microsoft Windows is commonly installed with a standard Windows input method. However, the standard Windows input method lacks a specific function of word autofilling and/or word autoselecting. As such, when adopting the standard Windows input method to write an article, a letter, or a program code on an edit page through a keyboard, user is required to input correct letters of English Alphabet with a corresponding number of the forgoing letters for making a single vocabulary word (or one sentence) be shown on the edit page. Therefore, it is surmised that, because there should be some users who are unable to spell out vocabulary word(s) correctly, or not memorize a certain amount of vocabulary words at all, the standard Windows input method certainly causes a speed delay of vocabulary words inputting for those users. Although there are some word processing programs which have been endowed with a wrong word inspecting function or a spell checking algorithm, resulted from the fact that there are a great amount of English homonyms, the wrong word inspecting function or the spell checking algorithm still cannot show an apparent efficiency on increasing the speed delay of vocabulary words inputting for above-mentioned users.

Accordingly, some input methods with the function of word autofilling or word autoselecting are hence developed and proposed. For instance, China patent publication NO. CN103677299A has disclosed a method for realizing intelligent association in an input method. From disclosures of the forgoing China patent, it is known that the method mainly comprises following steps:
(1) receiving a currently-inputted character codes in the case of a user typing a keyboard, wherein the currently-inputted character codes contain at least one phrase that consists of at least one vocabulary word;
(2) executing a vocabulary word searching process according to each of the vocabulary words, thereby generating at least one candidate vocabulary word, and then calculating a weight value of the candidate vocabulary word;
(3) carrying out an association combination between the candidate vocabulary word and at least one vocabulary words that are contained in a previously-inputted character codes provided in a previous typing of the user, and subsequently generating at least one combined keyword and a weight value thereof;
(4) re-calculating (or updating) the weight value of the candidate vocabulary word based on the weight value of the combined keyword, thereby showing at least one recommended vocabulary word for the user to select; wherein the recommended vocabulary word is generated based on the updated weight value of the candidate vocabulary word.

From above descriptions, it is aware of that the proposed method of China patent publication NO. CN103677299A leads the conventional input method to have a function of word autoselecting by using an intelligent association algorithm. However, the proposed method still fails to give the input method with a function of word autofilling. The most important thing is that, since the recommended vocabulary word is generated based on the currently-inputted character codes and the previously-inputted character codes, the method will produce at least one wrong or unsuitable recommended vocabulary word as long as the currently-inputted character codes contain incorrect vocabulary word or sentence. On the other hand, the proposed method is required to complete two times of weight value calculation and at least one time of vocabulary word searching process in order to achieve the generation of the recommended vocabulary word. As a result, such complex execution way certainly occupies a considerable computing resource of a processor of the user's computer device, causing the lowering of a user experience for the computer device.

From above descriptions, it is known that, to replace the convention input method that merely contains the function of word autoselecting with a newly-developed input method with functions of word autofilling and word autoselecting has become an important issue. In view of that, inventors of the present application have made great efforts to make inventive research and eventually provided an independent inputting device with self-learning function.

### SUMMARY OF THE INVENTION

A primary objective of the present invention is to provide an independent inputting device with self-learning function, which is adopted for being connected between a host device and a keyboard device, and is configured for memorizing and learning a user's specific habit of using English vocabulary word(s) or sentences. Therefore, during the user inputting a vocabulary word and/or a sentence, this independent inputting device is able to forecast what vocabulary word is that the user desires to input in the case of a number of inputted letters of the vocabulary word has reached a threshold integer (=N). Consequently, this independent inputting device automatically finishes the inputting of those un-inputted letters of the vocabulary word, such that the user does no longer continue the inputting of those un-inputted letters of the vocabulary word. As such, when the user adopts any one type of input method to edit a program code, write an article or a letter, or make statistical forms, inputting speed of the typed vocabulary words or sentence can be apparently increased by the independent inputting device of the present invention, thereby largely enhancing the user's work efficiency.

To achieve the foregoing objective, the present invention provides one embodiment for the independent inputting device with self-learning function, comprising:

a first connection unit for being connected to a host device;

a second connection unit for being connected to a keyboard device; and

a word input learning module, being coupled between the first connection unit and the second connection unit, and comprising:

a memory unit for storing at least one vocabulary word inputted by the keyboard device, wherein the vocabulary word constituted by M number of letters of English alphabet, and a number of the vocabulary words constitute at least one sentence;

an identification unit , being coupled to the memory unit, and being configured for applying an independent vocabulary word identifying process to any two of the vocabulary words that are stored in the memory unit, and/or applying an independent sentence identifying process to any two of the sentences that are stored in the memory unit;

a letter counting unit, being configured to count a letter serial number for each of the letters of English alphabet during the keyboard device inputting the vocabulary word that is constituted by the M number of the letters;

an occurrence frequency calculating unit, being coupled to the memory unit, and is adopted for applying an occurrence frequency calculating process to the vocabulary words that are stored in the memory unit, thereby obtaining an occurrence frequency of each of the vocabulary words; and

a word input autocompleting unit, being coupled to the occurrence frequency calculating unit and the letter counting unit;

wherein the word input autocompleting unit is configured for automatically executing a remaining letters autofilling in case of the letter serial number being serially counted to N, such that from a (N+1)-th letter to a M-th letter of the vocabulary word are inputted into the host device before the keyboard device completely inputs all of the letters of the vocabulary word;

wherein both M and N are an integer, and N being smaller than M.

In the embodiment of the foregoing independent inputting device, the memory unit is selected from the group consisting of memory chip component, memory card, and portable storage device.

In the embodiment of the foregoing independent inputting device, the word input autocompleting unit comprises:

an occurrence frequency comparator, being configured for applying a occurrence frequency comparing process between any two of the vocabulary words that are stored in the memory unit, so as to output an occurrence frequency comparison data;

a letter total number comparator, being configured for applying a letter total number comparing process between any two of the vocabulary words that are stored in the memory unit, so as to output a letter total number comparison data; and

a word input autocompleting controller, being coupled to the occurrence frequency comparator and the letter total number comparator;

wherein when the letter serial number is serially counted to N by the letter counting unit, the word input autocompleting controller executing the remaining letters autofilling according to the occurrence frequency of each of the vocabulary words that are stored in the memory unit, the letter total number comparison data, and/or the occurrence frequency comparison data.

In one embodiment of the foregoing independent inputting device, wherein in case of the letter serial number being serially counted to N, there being two or more numbers of the vocabulary words that contain the same first N numbers of the letters, and there being two or more numbers of the vocabulary words that have an occurrence frequency difference smaller than 10 times, the word input autocompleting controller executes the remaining letters autofilling according to the occurrence frequency of each of the vocabulary words, the letter total number comparison data, and/or the occurrence frequency comparison data after the letter serial number is serially counted to N+1.

In one embodiment of the foregoing independent inputting device, wherein in case of the letter serial number being serially counted to N and there being two or more numbers of the vocabulary words that contain the same first N numbers of the letters, the word input autocompleting controller executes the remaining letters autofilling after selecting a specific vocabulary word that contains a relatively smaller number of the letters.

In one embodiment of the foregoing independent inputting device, wherein in case of the letter serial number being serially counted to N and there being two or more numbers of the vocabulary words that contain the same first N numbers of the letters, the word input autocompleting controller executes the remaining letters autofilling after selecting a specific vocabulary word that contains a relatively more number of the letters.

In the embodiment of the foregoing independent inputting device, the keyboard device is a physical keyboard or a laser projection keyboard, and the integer for N being at least 4.

In one practicable embodiment, the foregoing independent inputting device further comprises a user interface, which is coupled to the word input autocompleting controller, such that a user is able to change the integer for N through the user interface.

In the embodiment of the foregoing independent inputting device, the first connection unit and the second connection unit are both selected from the group consisting of USB connector, Lightning connector, and wireless Bluetooth interface.

In the embodiment of the foregoing independent inputting device, wherein the identification unit comprises:

a blank symbol recognizer, being configured for completing the independent vocabulary word identifying process between any two of the vocabulary words by recognizing a blank symbol;

a comma symbol recognizer, being configured for completing the independent sentence identifying process between any two of the sentences by recognizing a comma symbol; and

a dot symbol recognizer, being configured for completing the independent sentence identifying process between any two of the sentences by recognizing a dot symbol.

### BRIEF DESCRIPTION OF THE DRAWINGS

FIG. 1 shows a first stereo diagram of an independent inputting device with self-learning function according to the present invention;

FIG. 2 shows a functional block diagram of the independent inputting device with self-learning function according to the present invention; and

FIG. 3 shows a second stereo diagram of the independent inputting device with self-learning function according to the present invention.

### DETAILED DESCRIPTION OF THE PREFERRED EMBODIMENT

The advantages and features of an independent inputting device with self-learning function according to the present invention are described in details with reference to examples of embodiments and accompanying drawings to be more easily understood. However, the present invention may be implemented in different forms, and should not be construed as limited to only embodiments described herein. Conversely, for a person skilled in the art, the embodiments are provided for making the disclosure more thorough and comprehensive and completely conveying the scope of the present invention.

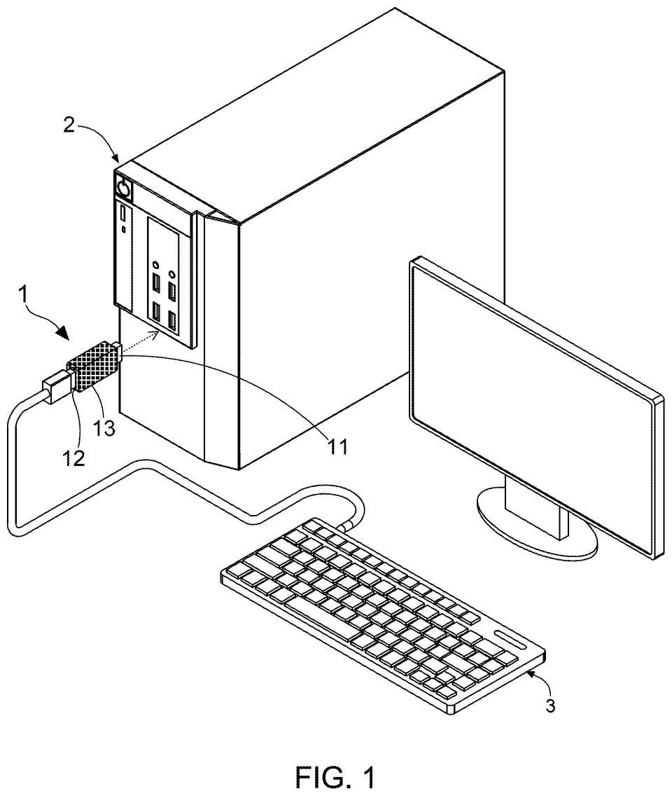

With reference to FIG. 1, there is provided a first stereo diagram of an independent inputting device with self-learning function according to the present invention. As FIG. 1 shows, the independent inputting device 1 of the present invention mainly comprises: a first connection unit 11, a second connection unit 12, and a word input learning module 13, wherein the first connection unit 11 is used for being connected to a host device 2, and the second connection unit 12 is adopted for being connected to a keyboard device 3. Moreover, the word input learning module 13 is coupled between the first connection unit 11 and the second connection unit 13. It needs to particularly explain that, although FIG. 1 depicts that the first connection unit 11 and the second connection unit 12 are both a USB connector, the USB connector does not be used for limiting the practicable embodiment of the first connection unit 11 and the second connection unit 12. In one practicable embodiment, both the first connection unit 11 and the second connection unit 12 can also be a Lightning connector or wireless a Bluetooth interface.

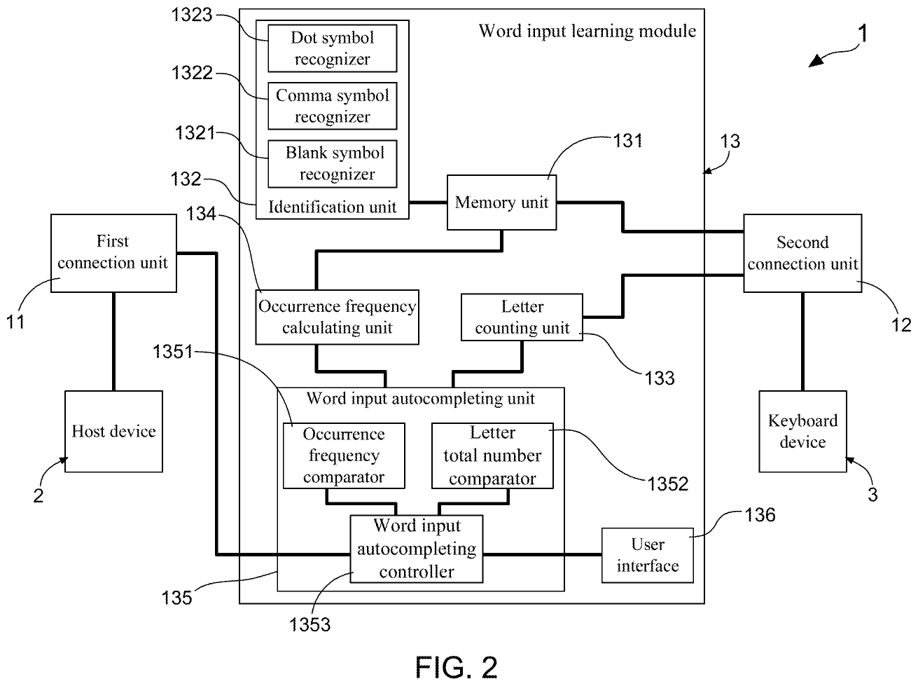

Referring to FIG. 1 again, and please simultaneously refer to FIG. 2, which illustrates a functional block diagram of the independent inputting device with self-learning function according to the present invention. In the present invention, the word input learning module 13 is designed to comprise a memory unit 131, an identification unit 132, a letter counting unit 133, an occurrence frequency calculating unit 134, and a word input autocompleting unit 135. The memory unit 131, such as a memory chip component, a memory card, or a portable storage device, is arranged for storing at least one vocabulary word inputted by the keyboard device 3, wherein the vocabulary word is constituted by M number of letters of English alphabet, and a number of the vocabulary words further constitute at least one sentence. On the other hand, the identification unit 132 is coupled to the memory unit 131, and is configured for applying an independent vocabulary word identifying process to any two of the vocabulary words that are stored in the memory unit 131, and/or applying an independent sentence identifying process to any two of the sentences that are stored in the memory unit 131. It is worth noting that, the identification unit 132 consists of a blank symbol recognizer 1321, a comma symbol recognizer 1322, and a dot symbol recognizer 1322. As described more in detail below, the blank symbol recognizer 1321 is configured for completing the independent vocabulary word identifying process between any two of the vocabulary words by recognizing a blank symbol (i.e., “”). Moreover, the comma symbol recognizer 1322 is configured for completing the independent sentence identifying process between any two of the sentences by recognizing a comma symbol (i.e., “,”). On the other hand, the dot symbol recognizer 1322 is configured for completing the independent sentence identifying process between any two of the sentences by recognizing a dot symbol (i.e., “.”).

Engineers skilled in design of firmware for electronic devices should know that, the blank symbol recognizer 1321, the comma symbol recognizer 1322, and the dot symbol recognizer 1322 are commonly edited to an application program (i.e., the identification unit 132) by a form library, variables, or operands, thereby being provided in the identification unit 13. In addition, as FIG. 2 shows, the letter counting unit 133 is configured to count a letter serial number for each of the letters of English alphabet during the keyboard device 3 inputting the vocabulary word that is constituted by the M number of the letters. Moreover, the occurrence frequency calculating unit 134 is coupled to the memory unit 131, and is adopted for applying an occurrence frequency calculating process to the vocabulary words that are stored in the memory unit 131, so as to obtain an occurrence frequency of each of the vocabulary words.

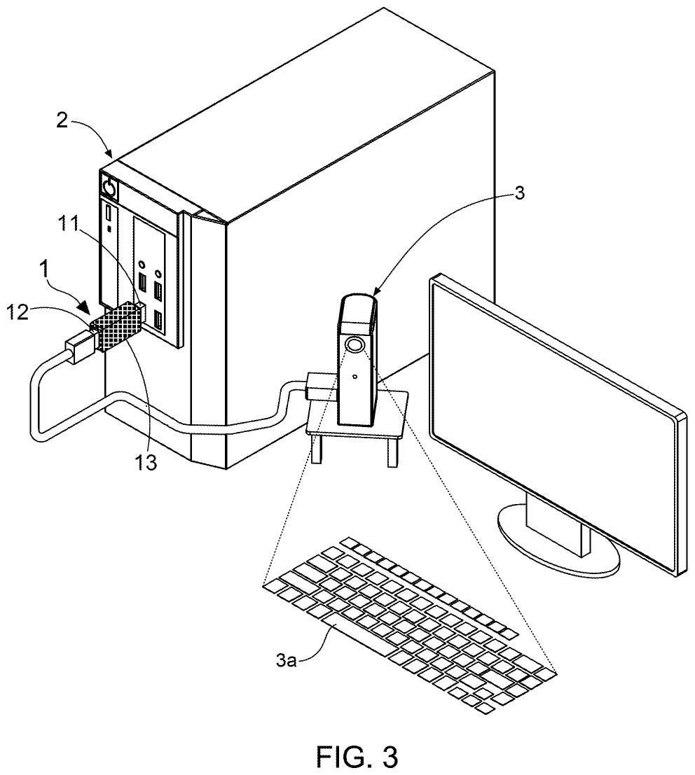

From FIG. 2 and FIG. 3, it is known that the word input autocompleting unit 135 is coupled to the occurrence frequency calculating unit 134 and the letter counting unit 133. According to the particular design of the present invention, the word input autocompleting unit 135 is configured for automatically executing a remaining letters autofilling in case of the letter serial number being serially counted to N by the letter counting unit 133, such that from a (N+1)-th letter to a M-th letter of the vocabulary word are inputted into the host device 2 before the keyboard device 3 completely inputs all of the letters of the vocabulary word. In which, both M and N are an integer, and N is at least 4 that is smaller than M. Likewise, the letter counting unit 133 and the occurrence frequency calculating unit 134 are also both edited to an application program by a form library, variables, or operands, thereby being provided in the identification unit 13. On the other hand, an occurrence frequency comparator 1351, a letter total number comparator 1352, and a word input autocompleting controller 1353 are further edited to an application program by a form library, variables, or operands, thereby being established in the word input autocompleting unit 135.

In the present invention, the occurrence frequency comparator 1351 is configured for applying a occurrence frequency comparing process between any two of the vocabulary words that are stored in the memory unit 131, so as to output an occurrence frequency comparison data. Moreover, the letter total number comparator 1352 is configured for applying a letter total number comparing process between any two of the vocabulary words that are stored in the memory unit 131, so as to output a letter total number comparison data. On the other hand, the word input autocompleting controller 1353 is coupled to the occurrence frequency comparator 1351 and the letter total number comparator 1352. By such arrangements, when the letter serial number is serially counted to N (such as N=4) by the letter counting unit 133, the word input autocompleting controller 1353 executing the remaining letters autofilling according to the occurrence frequency of each of the vocabulary words that are stored in the memory unit 131, the letter total number comparison data, and/or the occurrence frequency comparison data.

For instance, in case of a user being inputting a vocabulary word “instagram” through the keyboard device 3, the independent inputting device 1 would automatically search relative vocabulary words in the memory unit 131 after the user has completed the input of the first four numbers of the letters (i.e., “inst”). Therefore, there are a few of relative vocabulary words found out from the memory unit 131, like instagram, install, and instantpudding. Subsequently, in the eventuality of the occurrence frequency comparison data of the forgoing three vocabulary words indicate that the occurrence frequency of the vocabulary word “instagram” is greater than that of other two relative vocabulary words, the a (N+1)-th (i.e., fourth) letter to a M-th (i.e., ninth) letter of the vocabulary word “instagram” are inputted into the host device 3 before the keyboard device 2 completely inputs all of the letters of the vocabulary word “instagram”. Herein, it needs to particularly emphasize that, above-described specific way for activating the word input autocompleting controller 1353 to execute the remaining letters autofilling is defined as rule I.

On the other hand, FIG. 2 also depicts that the word input autocompleting unit 135 further comprises a user interface 136, which is coupled to the word input autocompleting controller 1353, such that a user is able to change the integer for N through the user interface 136. As such, when the user adopts one input method to edit a program code, write an article or a letter, or make statistical forms, the user can decide the value of N by operating the user interface 136. Therefore, inputting speed of the vocabulary words that are typed by the user can be apparently increased by the independent inputting device 1 of the present invention, thereby largely enhancing the user's work efficiency.

However, it is known that there are two or more numbers of the vocabulary words that contain the same first N (such as N=4) numbers of the letters. In such case, the word input autocompleting controller 1353 executes the remaining letters autofilling after selecting a specific vocabulary word from the memory unit 131, wherein the selected vocabulary word contains a relatively more number of the letters. Following Table (1) shows an example for further explaining above-described vocabulary word selecting rule. From Table (1), it is found that both the “instagram” and the “install” have an occurrence frequency of 50 times. In such case, after the user has completed the input of the first four numbers of the letters (i.e., “inst”), the word input autocompleting controller 1353 would automatically input those un-inputted letters of the “instagram” (i.e., “agram”) into the host device 3 before the user completely inputs all of the letters of the “instagram”.

TABLE (1)

| | occurrence frequency |
|---|---|
| vocabulary word | (times) |
| instagram | 50 |
| install | 50 |

Of course, the independent inputting device 1 of the present invention allows the user to change to above-described vocabulary word selecting rule by operating the user interface 136. For example, after the user has changed the vocabulary word selecting rule, the word input autocompleting controller 1353 executes the remaining letters autofilling after selecting a specific vocabulary word from the memory unit 131, wherein the selected vocabulary word contains a relatively smaller number of the letters.

Herein, it needs to particularly emphasize that, above-described specific way for activating the word input autocompleting controller 1353 to execute the remaining letters autofilling is defined as rule II. On the other hand, it is possible to have a special case of there being two or more numbers of the vocabulary words that contain the same first N numbers of the letters as well as there being two or more numbers of the vocabulary words that have an occurrence frequency difference smaller than 10 times. In such case, the word input autocompleting controller 1353 executes the remaining letters autofilling according to the occurrence frequency of each of the vocabulary words, the letter total number comparison data, and/or the occurrence frequency comparison data after the letter serial number is serially counted to N+1. Following Table (2) shows an example for further explaining above-described vocabulary word selecting rule. From Table (2), it is found that the “instagram”, the “install” and the “instantpudding” have the same first four numbers of the letters (i.e., “inst”). Moreover, because the three vocabulary words have different occurrence frequencies of 56, 52 and 49, it is known that the occurrence frequency difference between any two of the three vocabulary words is smaller than 10. In such case, the word input autocompleting controller 1353 would not execute the remaining letters autofilling until the user has complete the (N+1)-th (i.e., fifth) numbers of the letters of the “instagram”.

TABLE (2)

| | occurrence frequency |
|---|---|
| vocabulary word | (times) |
| instagram | 56 |
| install | 52 |
| instantpudding | 49 |

It needs to particularly emphasize that, above-described specific way for activating the word input autocompleting controller 1353 to execute the remaining letters autofilling is defined as rule III. Of course, it is possible to have another special case of there being two or more numbers of the vocabulary words that contain the same first five numbers of the letters as well as there being two or more numbers of the vocabulary words that have an occurrence frequency difference smaller than 10 times. In such case, after the letter serial number is serially counted to N+1 by the letter counting unit 133, the word input autocompleting controller 1353 starts to execute the remaining letters autofilling according to the occurrence frequency of each of the vocabulary words, the letter total number comparison data, and/or the occurrence frequency comparison data.

Herein, it needs to further explain that, although FIG. 1 depicts that the keyboard device 3 is a physical keyboard, the physical keyboard is not used for limiting the practicable embodiment of the keyboard device. FIG. 3 shows a second stereo diagram of the independent inputting device with self-learning function according to the present invention. From FIG. 3, it is understood that, the keyboard device 3 can also be a laser projection keyboard in one practicable embodiment. As such, the laser projection keyboard is configured to project a virtual keyboard 3a on a plane, and then the user is able to input at least one vocabulary word into the host device 3, wherein the inputted vocabulary word is constituted by M number of letters of English alphabet.

Through above descriptions, all embodiments and their constituting elements of the independent inputting device with self-learning function proposed by the present invention have been introduced completely and clearly; in summary, the present invention includes the advantages of:

(1) The present invention discloses an independent inputting device 1 with self-learning function, which is adopted for being connected between a host device 2 and a keyboard device 3, and is configured for memorizing and learning a user's specific habit of using English vocabulary word(s) or sentences. The independent inputting device 1 of the present invention mainly comprises a first connection unit 11, a second connection unit 12, and a word input learning module 13. During the user inputting a vocabulary word and/or a sentence, this independent inputting device 1 is able to forecast what vocabulary word is that the user desires to input in case of a number of an inputted letters of the vocabulary word has reached a threshold integer (═N). Consequently, this independent inputting device 1 automatically finishes the inputting of those un-inputted letters of the vocabulary word, such that the user does no longer continue the inputting of those un-inputted letters of the vocabulary word. As such, when the user adopts any one type of input method to edit a program code, write an article or a letter, or make statistical forms, inputting speed of the typed vocabulary words or sentence can be apparently increased by the independent inputting device 1 of the present invention, thereby largely enhancing the user's work efficiency.

Any modification to the present invention made by a person skilled in the art does not depart from the protection scope defined by the appended claims.

What is claimed is:

1. An independent inputting device with self-learning function, comprising:
a first connection unit for being connected to a host device;
a second connection unit for being connected to a keyboard device; and
a word input learning module, being coupled between the first connection unit and the second connection unit, and comprising:
a memory unit for storing at least one vocabulary word inputted by the keyboard device, wherein the vocabulary word constituted by M number of letters of English alphabet, and a number of the vocabulary words constitute at least one sentence;
an identification unit, being coupled to the memory unit, and being configured for applying an independent vocabulary word identifying process to any two of the vocabulary words that are stored in the memory unit, and/or applying an independent sentence identifying process to any two of the sentences that are stored in the memory unit;
a letter counting unit, being configured to count a letter serial number for each of the letters of English alphabet during the keyboard device inputting the vocabulary word that is constituted by the M number of the letters;
an occurrence frequency calculating unit, being coupled to the memory unit, and is adopted for applying an occurrence frequency calculating process to the vocabulary words that are stored in the memory unit, thereby obtaining an occurrence frequency of each of the vocabulary words; and
a word input autocompleting unit, being coupled to the occurrence frequency calculating unit and the letter counting unit;
wherein the word input autocompleting unit is configured for automatically executing a remaining letters autofilling in case of the letter serial number being serially counted to N, such that from a (N+1)-th letter to a M-th letter of the vocabulary word are inputted into the host device before the keyboard device completely inputs all of the letters of the vocabulary word;
wherein both M and N are an integer, and N being smaller than M.

2. The independent inputting device according to claim 1, wherein the memory unit is selected from the group consisting of memory chip component, memory card, and portable storage device.

3. The independent inputting device according to claim 1, wherein the word input autocompleting unit comprises:
an occurrence frequency comparator, being configured for applying a occurrence frequency comparing process between any two of the vocabulary words that are stored in the memory unit, so as to output an occurrence frequency comparison data;
a letter total number comparator, being configured for applying a letter total number comparing process between any two of the vocabulary words that are stored in the memory unit, so as to output a letter total number comparison data; and
a word input autocompleting controller, being coupled to the occurrence frequency comparator and the letter total number comparator;
wherein when the letter serial number is serially counted to N by the letter counting unit, the word input autocompleting controller executing the remaining letters autofilling according to the occurrence frequency of each of the vocabulary words that are stored in the memory unit, the letter total number comparison data, and/or the occurrence frequency comparison data.

4. The independent inputting device according to claim 3, wherein in case of the letter serial number being serially counted to N, there being two or more numbers of the vocabulary words that contain the same first N numbers of the letters, and there being two or more numbers of the vocabulary words that have an occurrence frequency difference smaller than 10 times, the word input autocompleting controller executing the remaining letters autofilling according to the occurrence frequency of each of the vocabulary words, the letter total number comparison data, and/or the occurrence frequency comparison data after the letter serial number is serially counted to N+1.

5. The independent inputting device according to claim 3, wherein in case of the letter serial number being serially counted to N and there being two or more numbers of the vocabulary words that contain the same first N numbers of the letters, the word input autocompleting controller executing the remaining letters autofilling after selecting a specific vocabulary word that contains a relatively smaller number of the letters.

6. The independent inputting device according to claim 3, wherein in case of the letter serial number being serially counted to N and there being two or more numbers of the vocabulary words that contain the same first N numbers of the letters, the word input autocompleting controller executing the remaining letters autofilling after selecting a specific vocabulary word that contains a relatively more number of the letters.

7. The independent inputting device according to claim 4, wherein the keyboard device is a physical keyboard or a laser projection keyboard, and the integer for N being at least 4.

8. The independent inputting device according to claim 7, further comprising a user interface, being coupled to the word input autocompleting controller, such that a user is able to change the integer for N through the user interface.

9. The independent inputting device according to claim 1, wherein the first connection unit and the second connection unit are both selected from the group consisting of USB connector, Lightning connector, and wireless Bluetooth interface.

10. The independent inputting device according to claim 1, wherein the identification unit comprises:
a blank symbol recognizer, being configured for completing the independent vocabulary word identifying process between any two of the vocabulary words by recognizing a blank symbol;
a comma symbol recognizer, being configured for completing the independent sentence identifying process between any two of the sentences by recognizing a comma symbol; and
a dot symbol recognizer, being configured for completing the independent sentence identifying process between any two of the sentences by recognizing a dot symbol.
